(19) United States
(12) Patent Application Publication
(10) Pub. No.: US 2015/0277813 A1
(43) Pub. Date: Oct. 1, 2015

(54) INFORMATION COMMUNICATION SYSTEM, INFORMATION PROCESSING DEVICE AND INFORMATION COLLECTING METHOD

(71) Applicant: SEIKO EPSON CORPORATION, Tokyo (JP)

(72) Inventor: Yasuhito NAGATOMO, Shiojiri-shi (JP)

(21) Appl. No.: 14/665,473

(22) Filed: Mar. 23, 2015

(30) Foreign Application Priority Data
Mar. 26, 2014 (JP) 2014-064822

(51) Int. Cl. G06F 3/12

(52) U.S. Cl. CPC G06F 3/1212; G06F 3/122; G06F 3/1275; G06F 3/1287

(57) ABSTRACT

An information communication system includes an information processing device, and an information collecting device that communicates with the information processing device and collects information from the information processing device, wherein the information processing device has an information acquisition section that acquires a plurality of kinds of operating information which change in response to the operation of the information processing device, a data generation section that generates data for transmission on the basis of the plurality of kinds of operating information and a predetermined data generation rule, and a communication section that transmits the data for transmission to the information collecting device, and wherein the information collecting device has a storage section that stores the data for transmission transmitted from the information processing device, and a change section that changes the data generation rule of the data generation section via the communication section of the information processing section.

### BACKGROUND

1. Technical Field

The present invention relates to an information processing device having a communication function.

2. Related Art

Some information processing devices (such as a local area network (LAN)) that have communication functions via communication lines are configured to transmit operation information to an information collecting device which is connected to the information processing device via a communication line. Such operation information changes in response to the operation of the information processing device. The transmitted information can be used in remote monitoring of the information processing device. When such operation information is collected from multiple information processing devices and integrated, the integrated information can be used for the analysis of causes of failure in the information processing devices to prevent failure from occurring. This can be helpful, as feedback, for developing products.

There are various kinds of information which indicate operation conditions of an information processing device. If all of such information is integrally managed, huge storage resources are required, and also the load on the communication line increases. Thus, the amount of information to be managed needs to be reduced. As a feature that addresses this problem, a feature described in JP-A-2008-152541, for example, is proposed. In the feature of JP-A-2008-152541, when an event log is generated in a print device, the event log is temporarily stored for each occasion, and thereafter, only events to be analyzed are extracted and stored while data on other events is not stored.

When the feature of the related art is applied to collecting of operation information via a communication line, the following problems occur. In the feature of the related art, whether or not to store a generated event (corresponding to operation information) is determined on the basis of predetermined decision criteria. However, in a process of collecting operation information from multiple individual devices and analyzing the collected operation information, it sometimes becomes clear that less useful information has been collected, and that, conversely, necessary information has not been collected. If all of the operation information is transmitted in order to address such problems, large loads are imposed on the storage resources of the information collecting device and on the communication line. The feature of the related art, in which the decision criteria for selecting information have been determined in advance, could not have handled such a situation.

### SUMMARY

An advantage of some aspects of the invention is that operation information transmitted from an information processing device is optimized, thereby reducing loads on storage resources and communication lines.

An information communication system according to a first aspect of the invention includes an information processing device, and an information collecting device that communicates with the information processing device and collects information from the information processing device, wherein the information processing device has an information acquisition section that acquires a plurality of kinds of operating information which change in response to the operation of the information processing device, a data generation section that generates data for transmission on the basis of the plurality of kinds of operating information and a predetermined data generation rule, and a communication section that transmits the data for transmission to the information collecting device, and wherein the information collecting device has a storage section that stores the data for transmission transmitted from the information processing device, and a change section that changes the data generation rule of the data generation section via the communication section of the information processing section.

According to the first aspect of the invention, the data generation rule that is used to generate data for transmission, which is transmitted to the information collecting device, from operation information obtained in the information processing device can be modified by operation by the information collecting device. Therefore, if, for example, the operation information collected by the information collecting device is analyzed and it is determined that the current generation rule is not appropriate, data for transmission is optimized after updating the generation rule. Consequently, unnecessary data transmission can be avoided, and loads on storage resources and a communication line can be reduced. Meanwhile, the information specifying the generation rule includes information indicating which operation information obtained in the information processing device is used, and information on data processing method for reducing the amount of data of the obtained operation information.

It is preferable that, for example, the information collecting device be configured to be capable of communicating with a plurality of information processing devices connected to a communication line, and that the storage section be configured to store data for transmission transmitted from the plurality of information processing devices. In a case where the information collecting device collects information from a plurality of information processing devices, the amount of data is increased and therefore, the reduction of the amount is particularly necessary. On the other hand, analysis based on a statistical method can be performed by collecting information from a plurality of information processing devices, and therefore operation information of high importance and that of low importance can be easily distinguished from each other. Thus, the data generation rule can be optimized efficiently.

In this case, the information collecting device may be configured to include an evaluation section that evaluates the validity of the plurality of kinds of operating information on the basis of the data for transmission transmitted from the plurality of information processing devices, and that creates a new data generation rule on the basis of an evaluation result. According to this configuration, the data generation rule can be created according to the validity of the plurality of kinds of operation information.

Furthermore, the data generation section may be configured to run preset firmware to operate the information processing device, the data generation rule may be configured to be described in a script which can be updated and is called by the firmware, and the change section may be configured to update the script via the communication section. According to this configuration, the data generation rule can be modified by only updating the script relating to data transmission.

An information processing device according to a second aspect of the invention includes an information processing section, an information acquisition section that acquires a plurality of kinds of operating information which change in response to the operation of the information processing section, a data generation section that generates data for transmission on the basis of the plurality of kinds of operating information and a predetermined data generation rule, and a communication section that transmits the data for transmission to outside, wherein the data generation section is configured to be capable of changing the data generation rule according to information received by the communication section from outside.

According to the second aspect of the invention, the data generation rule, which is used to generate data for transmission from operation information, can be modified from the outside via the communication section. Therefore, the way of transmitting the plurality of kinds of operation information can be changed dynamically.

It is preferable that the data generation section of the information processing device be configured to run preset firmware to operate the information processing device, and that the data generation rule be configured to be described in a script which can be updated and is called by the firmware. According to this configuration, as with the case of the abovementioned information communication system, the data generation rule can be modified by only updating the script relating to data transmission.

In this case, the information acquisition section may have a sensor that detects a physical parameter which changes in response to the operation of the information processing section, and an output signal of the sensor may be used as the operation information. In addition, the information acquisition section may have a counter that counts a numerical value which changes in response to the operation of the information processing section, and an output signal of the counter may be used as the operating information. According to this configuration, the operation condition of the information processing section can be quantitatively represented by the output of the sensor or the counter, whereby control of the information processing section can be facilitated.

Furthermore, it is preferable that the information processing section be configured to have an image forming section that forms an image based on image data on a recording medium. The image forming section of this type is formed of many component parts including movable parts and consumables, and the operation condition of each component part affects greatly on the operation condition of the entire device. Therefore, collecting of the operation information on these component parts is especially useful. Thus, a significant effect can be obtained when this configuration is applied to such a section.

An information collecting method for collecting information from an information processing device connected to a communication line, according to a third aspect of the invention includes receiving, from the information processing device, data for transmission that is generated on the basis of a plurality of kinds of operation information which change in response to the operation of the information processing device and a data generation rule given in advance to the information processing device, storing the received data for transmission, and updating the data generation rule on the basis of the data for transmission.

According to the third aspect of the invention, the data generation rule for generating data for transmission, the data generation rule being given in advance to the information processing device, can be modified dynamically and ex post facto upon the data that has been actually generated is received. Therefore, the data for transmission to be transmitted from the information processing device can be optimized in both viewpoints of information management and load on the communication line. Consequently, loads on the storage resources in which operation information is stored and on the communication line can be reduced.

In this case, the information collecting method may be configured to evaluate the validity of the plurality of kinds of operating information on the basis of the data for transmission transmitted from a plurality of information processing devices to create a new data generation rule on the basis of an evaluation result. According to this configuration, the data generation rule can be created according to the validity of the plurality of kinds of operation information.

It is preferable that the information collecting method receive the data for transmission from a plurality of information processing devices which are connected to a communication line, and store the data for transmission. According to this configuration, operation information transmitted from the plurality of information processing devices is accumulated, whereby the accumulated information can be used for the analysis of operation conditions of the devices and the analysis of failure causes.

### BRIEF DESCRIPTION OF THE DRAWINGS

The invention will be described with reference to the accompanying drawings, wherein like numbers reference like elements.

FIG. 1 illustrates an information communication system according to an embodiment of the invention.

FIG. 2 is a block diagram illustrating a configuration of a computer and a printer.

FIG. 3 is a block diagram illustrating a configuration of a server.

FIG. 4A illustrates an example of a data transmission mode from a printer to a server.

FIG. 4B illustrates another example of a data transmission mode from a printer to a server.

FIG. 5A is a view of processing of operation information in the information communication system.

FIG. 5B is another view of processing of operation information in the information communication system.

FIG. 6 is a flowchart illustrating operation on the printer side.

FIG. 7 is a flowchart illustrating operation on the server side.

FIG. 8A illustrates a relationship between a system configuration and a storage location of a script file.

FIG. 8B illustrates another relationship between a system configuration and a storage location of a script file.

FIG. 8C illustrates yet another relationship between a system configuration and a storage location of a script file.

### DESCRIPTION OF EXEMPLARY EMBODIMENTS

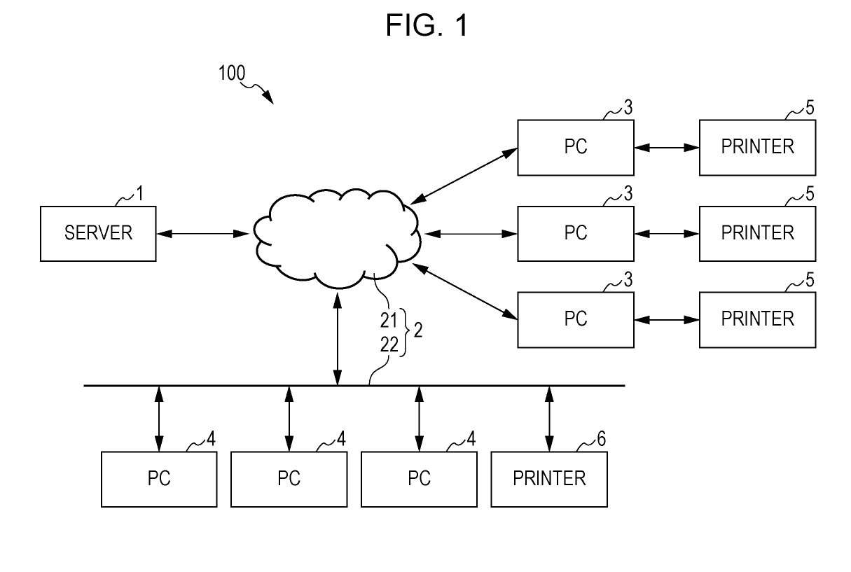

FIG. 1 illustrates an information communication system according to an embodiment of the invention. An information communication system 100 includes a server 1, personal computers (PCs) 3, 4 and printers 5, 6, each being interconnected to the others via communication lines. More specifically, in the information communication system 100, the server 1 and a plurality of personal computers 3 (hereinafter referred to simply as “computer”, and indicated as “PC” in the drawings) are connected to an Internet communication network 21. In addition, a local area network (LAN) 22 installed in an office, for example, is connected to the Internet communication network 21, and a plurality of computers 4 are connected to the LAN 22.

The computers 3 are connected to and control the respective printers 5. The printer 6 is connected to the LAN 22, and can be controlled by the computers 4, which are connected to the LAN 22.

Meanwhile, the information communication system 100 is established by connecting a server to at least one computer or printer via a communication line. Therefore, the numbers of the computers and the printers are not fixed, and are not limited to those in the drawings. Furthermore, the connection mode may be either a mode (as with the computer 3) in which a connection to the server 1 is established via the Internet communication network 21, or a mode (as with the computer 4) in which a connection to the server 1 is established via the LAN 22 and the Internet communication network 21. Moreover, the connection mode may be a mode in which the server 1 and the computer 4 are interconnected with each other via the LAN 22 without using the Internet communication network 21. The Internet communication network 21 and the LAN 22 are hereinafter collectively referred to as a communication line 2, unless it is necessary to distinguish the terms. The communication line 2 may be a wired link or a wireless link, as long as two-way communication can be performed.

In addition, for the printers, the connection mode may be either a mode (as with the printer 5) in which a connection to the communication line 2 is established indirectly via the computer 3, or a mode (as with the printer 6) in which a connection to the communication line 2 is established directly without using a computer. In this case, the printer 6 (which is directly connected to the communication line 2) is required to have a network connecting function.

The information communication system 100 having such a configuration allows the server 1 to remotely monitor the printers 5 and 6 via the communication line 2. A configuration of elements necessary for the remote monitoring is described below.

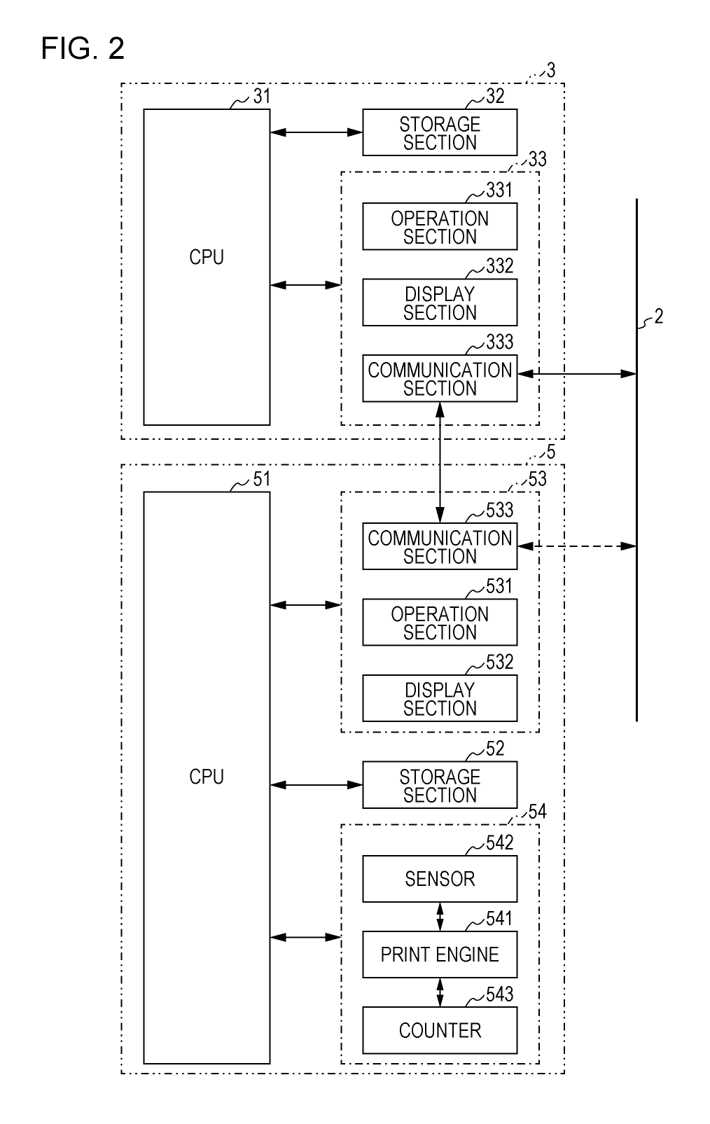

FIG. 2 is a block diagram illustrating a configuration of a computer and a printer. The computer 3 includes a central processing unit (CPU) 31 that executes various computing processes, a storage section 32 that stores various kinds of information, and an interface section 33 that exchanges information with the outside. A personal computer having a general configuration may be used as the computer 3. In such a computer, various functions can be realized by installing appropriate software. In this case, a configuration for realizing functions relating to the remote monitoring of printers will be described. Although a configuration of the computer 3 will be described as an example, a similar configuration is used in the computer 4.

The CPU 31 of the computer 3 controls each section of the computer 3 to execute specific processing by running software stored in the storage section 32. The storage section 32 is formed of a memory and a large capacity storage, for example, and stores various data items generated in association with the control programs and processing executed by the CPU 31. As described below, the storage section 32 also functions to accumulate and store operation information generated in association with the operation of the printer 5.

To serve as user interfaces, the interface section 33 includes an operation section 331 that receives operation input from a user, and a display section 332 that displays various kinds of information to inform the user thereof. The operation section 331 has an input device such as a keyboard or a mouse. The display section 332 has a display device such as a liquid crystal display. Alternatively, a touch panel may be used that functions as both the operation section 331 and the display section 332.

The interface section 33 also has a communication section 333 that communicates with other devices to exchange data. The communication section 333 has a network connecting function to connect to the communication line 2, as well as a function to communicate with the printer 5, which is connected to the computer 3. Specifically, the communication section 333 transmits a print instruction transmitted by the CPU 31 and image data indicating the content of an image to be printed, to the printer 5, thereby causing the printer 5 to execute a specified print operation.

The printer 5 is an image forming device that forms an image on a recording medium, such as paper, cloth, a resin sheet, or a metal sheet, by using a recording material, such as ink or toner. Although any system among various printing systems can be applied to the printer 5, an ink jet system may be used, for example. The printer 5 includes a CPU 51 that runs previously stored firmware to control each section, a storage section 52 that temporarily stores image data to be printed, an interface section 53 that exchanges information with the outside, and a print section 54 that executes a print operation in response to a control instruction transmitted by the CPU 51.

To serve as user interfaces, the interface section 53 includes an operation section 531 that has buttons which receive operation input from a user, and a display section 532 that displays various kinds of information and informs the user thereof. These sections may, for example, be integrally constituted as a touch panel. The interface section 53 also includes a communication section 533 that is connected to the communication section 333 of the computer 3, receives print instructions and image data transmitted from the computer 3, and transmits information indicating the condition of the printer 5.

The print section 54 includes a print engine 541 that is a primary component for print operations. The print engine 541 forms an image corresponding to image data on a recording medium in response to a control instruction transmitted by the CPU 51. The print section 54 is also provided with sensors 542 that detect various physical parameters relating to the operation condition of the print engine 541, and counters 543 that count various numerical values which change in response to the operation of the print engine 541.

If the print engine 541 is that of an ink jet system, the physical parameters indicating the operation condition thereof include, for example, a voltage applied to an electrical component of the print engine 541, temperature and humidity inside the printer, and positions of a print head and a recording medium. As the sensors 542 that detect these physical parameters, various sensors are provided, such as a voltage sensor, a temperature and humidity sensor, a position sensor, and an acceleration sensor. In addition, the numerical values, which change in response to the operation of the print engine 541, include, for example, the total operating time of the printer, the number of printed sheets, the quantity of used ink (or the quantity of remaining ink), and the cumulated number of rotations of a rotating mechanism component. Further, various counters 543 are provided that respectively count these numerical values.

Data output from each of the sensors 542 and the counters 543 is stored in the storage section 52 as operation information that indicates the operation condition of the printer 5, and is used for operation control of the print engine 541 by the CPU 51. In addition, the operation information is also transmitted to the computer 3 via the communication section 533. The computer 3 stores the operation information in the storage section 32, and monitors the condition of the printer 5. Furthermore, by transmitting the operation information from the computer 3 to the server 1, the server 1 can remotely monitor the printer 5.

The printer 6, which is directly connected to the communication line 2, also has the same basic configuration as the printer 5. However, the printer 6 is required to be a network printer in which a communication section 533 has a network connecting function to connect to and communicate with the communication line 2, as illustrated with a broken-line arrow in FIG. 2.

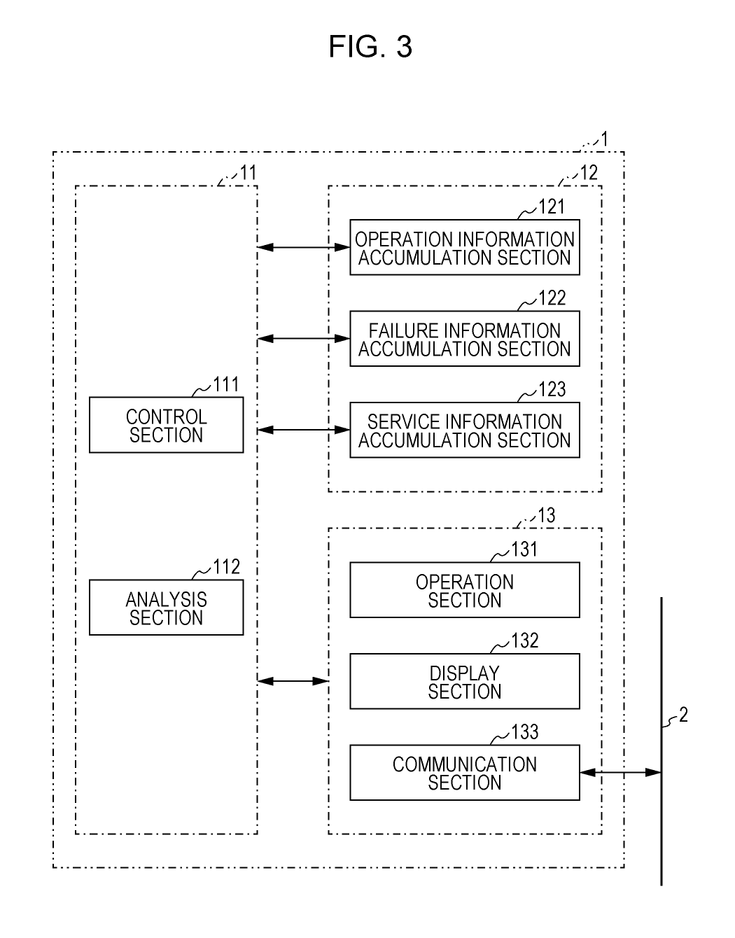

FIG. 3 is a block diagram illustrating a configuration of a server. The server 1 is installed by a service provider, which provides maintenance services for the printer 5, 6 to a user who installs and operates the printer 5, 6, in order to remotely monitor the printer 5, 6. The server 1 includes a CPU 11 that controls each section of the server 1 to execute specific processing, a data accumulation section 12 that accumulates various kinds of data and configures a database, and an interface section 13 that exchanges information with the outside.

The CPU 11 includes a control section 111 that runs a preset control program to cause each section of the server device 1 to perform a specific operation, and an analysis section 112 that performs appropriate analysis processing on the basis of obtained data. The data accumulation section 12 includes an operation information accumulation section 121, a failure information accumulation section 122, and a service information accumulation section 123. The functions of these sections will be described later.

To serve as user interfaces, the interface section 13, includes an operation section 131 that receives operation input from a user (an operator), and a display section 132 that displays various kinds of information to inform the operator thereof. The operation section 131 has an input device such as a keyboard or a mouse. The display section 132 has a display device such as a liquid crystal display. The interface section 13 also has a communication section 133 that communicates with other devices to exchange data. The communication section 133 has a network connecting function to connect to the communication line 2.

In the information communication system 100 configured as described above, various kinds of operation information (which change in response to the operations of the printers 5 and 6) are transmitted to the server 1 from the computer 3, and the computer 4 or the printer 6 via the communication line 2. The server 1 separately stores the operation information of the printers 5 and 6 in the operation information accumulation section 121, whereby the operation conditions and the histories thereof of the printers 5 and 6 are accumulated in the server 1. In this way, the operation information, which was obtained from the printers 5 and 6 and accumulated in the server 1, is provided for the remote monitoring of the printers 5 and 6.

Furthermore, the operation information (which is obtained from a plurality of the printers and then accumulated in the server 1) is analyzed by the analysis section 112, whereby prediction of a failure in a printer and analysis of the cause can be performed. An analysis result can be used as information for development of a new product. Specifically, when a failure occurs in a printer, information relating to the failure condition, which is obtained via the communication line 2 or a service person who performs a maintenance operation at the location of the printer, is stored as failure information in the failure information accumulation section 122. Then, the analysis section 112 performs correlation analysis between the operation information accumulated in the operation information accumulation section 121 and the failure information accumulated in the failure information accumulation section 122 to obtain a causal relationship between the operation information and the failure.

Thus, when a failure occurs in the printer 5 or 6, for example, the service provider can easily find the type and the cause of the failure and a way of handling the failure from the operation information of the printer. In addition, by assessing the history of the operation information of a printer connected to the communication line 2, it is possible to predict the occurrence of failure, and it is possible to prevent the failure from occurring by taking measures when the prediction is obtained. In this way, the server 1 can remotely monitor the printers 5 and 6 by using the accumulated operation information.

Appropriate service information can be transmitted to the printer 5, 6, which is subjected to the remote monitoring, when the server 1 or an operator who manages the printer determines that it is necessary. That is, in the service information accumulation section 123, multiple kinds of service information according to the conditions of the printers 5 and 6 are converted to data and stored in a database. The service information is information relating mainly to the maintenance of the printers 5 and 6, such as information on a method of cleaning the heads of the printers 5 and 6, and information on replacement of consumables.

In response to the operation condition of the printer 5, 6, appropriate service information is displayed for the user, whereby the user can prevent failure from occurring and increase the operation rate; that is, a useful service is provided to the users. In order to provide such a service, various kinds of operation information need to be transmitted to the server 1 from the printer 5, 6. The operation of each section for the data transmission will be described below.

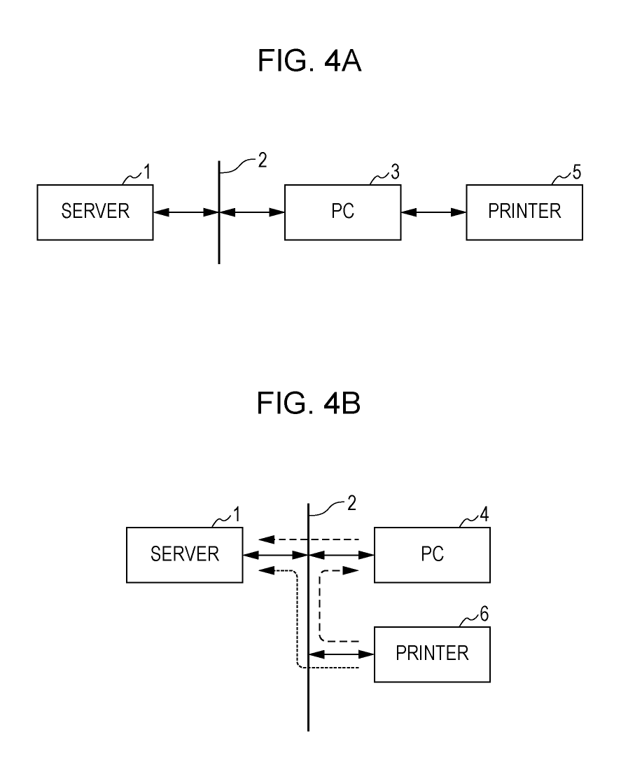

FIGS. 4A and 4B illustrate examples of data transmission modes from a printer to a server. One connection mode of the printer to the communication line 2 is a mode in which the printer 5 is connected to the communication line 2 via the computer (PC) 3 connected to the communication line 2, as illustrated in FIG. 4A. In this case, the data transmission mode is one in which the computer 3 that received operation information from the printer 5 transmits the operation information to the server 1 via the communication line 2.

The other connection mode is a mode in which the printer 6 is directly connected to the communication line 2, as illustrated in FIG. 4B. In this case, there are two possible data transmission modes. One mode is that operation information is transmitted directly to the server 1 from the printer 6, as shown by a dotted-line arrow. The other mode is that operation information of the printer 6 is transmitted to the computer 4 that controls the printer 6, and then the operation information is transmitted to the server 1 from the computer 4, as shown by a broken-line arrow.

These data transmission modes differ only in the path of the operation information from the printers 5 and 6 and to the server 1, and in the object that performs the communication. These modes are basically the same in that a feature wherein the physical parameters and numerical values, which change in response to the operation of the print section 54 (FIG. 2) in the printer 5, 6, are obtained by the sensors 542 and counters 543, and the information is transmitted through functional blocks having communication functions and eventually received by the server 1. The data transmission mode of the information communication system 100 may be any one of the data transmission modes described above.

Next, contents of the operation information transmitted from the printer 5, 6 to the server 1 will be described. Various kinds of operation information are obtained from the printer 5, 6, and such information is obtained originally for the purpose of using the information in operation control in the printer 5, 6. Meanwhile, not all of the operation information obtained in the printer 5, 6 necessarily needs to be transmitted to the server 1. The purpose of the server 1 performing information collection is mainly for the remote monitoring of the printer 5, 6, and for the analysis of failure causes. It is preferable to avoid transmission to the server 1 via the communication line 2 of information that contributes less to the above purpose. This is because the operation information accumulation section 121, which stores the information, would need a large storage resource, and the load on the communication line 2 would increase due to the increase in the amount of data to be transmitted.

However, when the printers are produced, it is often the case that it is not clear which information among the operation information obtained in the printer 5, 6 is in accord with the above purpose. That is, the types of operation information that are usable for remote monitoring and analysis of failure causes often become clear only after printers that become available to consumers as products are used by multiple users in the various environments and information on the operation condition and on the tendency to fail is collected. Therefore, to prevent usable information from being lost, printers are often configured to transmit as much operation information as possible.

As a result, especially in a system in which multiple printers are connected to the communication line 2, a large amount of operation information is transmitted from these printers, thereby causing problems such as a shortage of storage capacity in the server 1 and excess traffic on the communication line 2. In order to avoid such problems, the information communication system 100 is configured so that the amount of data to be transmitted to the communication line 2 can be reduced as described below.

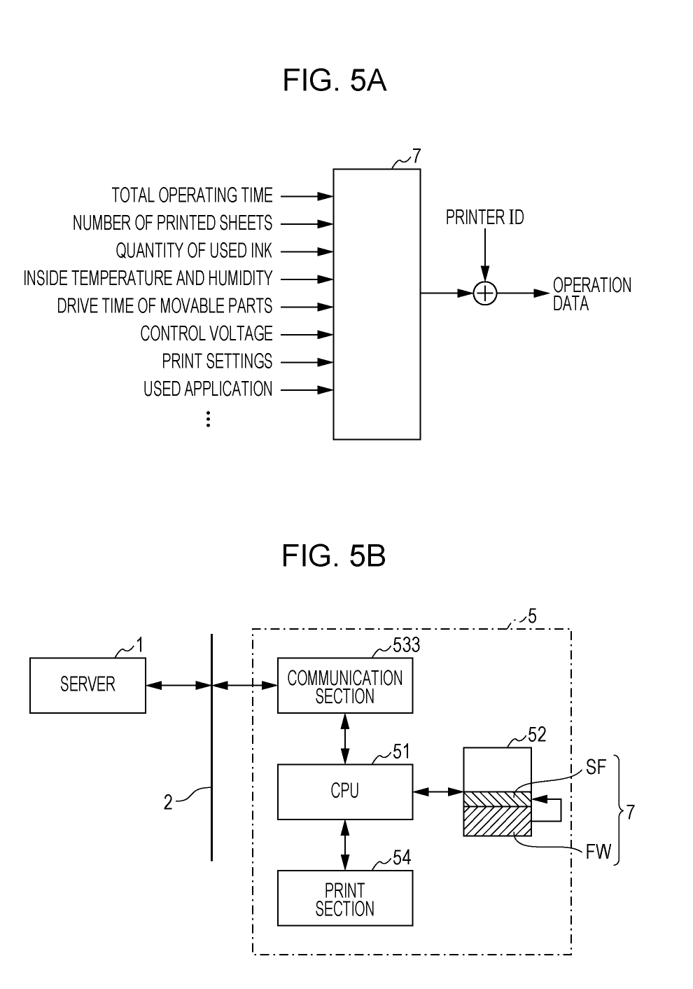

FIGS. 5A and 5B are views of processing of operation information in the information communication system. There are various kinds of operation information which change in response to the operation of the printer 5, 6, and examples thereof include the total operation time of the printer, the number of printed sheets, the quantity of used ink, the temperature and the humidity in the printer, the drive times of movable parts, the control voltages applied to electric parts, the print settings set by a user, and the name of applications used to create image data. In the information communication system 100, each kind of the operation information is input to a data calculation section 7 that performs a predetermined calculation, and then a printer ID for the identification of the printer is added to the output of the data calculation section 7. The resulting operation information is used as operation data to be transmitted to the server 1.

The data calculation section 7 performs calculation of operation information on the basis of a calculation rule that determines whether or not to include each kind of operation information, which has been input, in the calculation, and, if the input operation information is determined to be included, determines whether to transmit the operation information without or after being processed. More specifically, the data calculation section 7 excludes some of the multiple kinds of operation information from the information to be transmitted, and performs an arithmetic operation or a logical operation between the multiple kinds of operation information or between a plurality of operation information items of the same kind each having a different acquisition time, in order to generate operation data in which the amount of data is smaller than in a case where all operation information is transmitted.

As described above, when shipping the product, it is not clear which operation information among multiple kinds of operation information is usable. Therefore, it is preferable that the calculation rule of the data calculation section 7 not be fixed at that time. Rather, it is necessary that the calculation rule be modifiable ex post facto.

In a case where the data calculation section 7 is mounted in the printer 5, for example, the functions of the data calculation section 7 are realized by running firmware FW, which has been previously stored in the storage section 52, by the CPU 51, as illustrated in FIG. 5B. Note that the description relating to the calculation rule is stored in the storage section 52 as a script file SF that is provided separately from the firmware FW and called by the firmware FW. That is, the data calculation section 7 is realized as a virtual machine that is constituted of the firmware FW, which is run by the CPU 51, and the script file SF, which is called by the firmware FW. The firmware FW is configured so as to include a script execution module capable of executing such a script.

As described later, the script file SF can be updated by an update file which is transmitted from the server 1. By updating the script file SF, the calculation rule in the data calculation section 7 (which is realized as a virtual machine) is modified. That is, the server 1 can change and set ex post facto settings of the data calculation section 7, about which operation information is included in the operation data, and about which calculation is performed on the operation information.

With a configuration in which the script file SF, which is run by the firmware FW, is modified without modifying the firmware FW which controls operation of the printers 5 and 6, only the calculation rule can be modified without causing unstable operation of the printer 5, 6. That is, in a case where firmware FW is updated to modify a calculation rule, the printer 5, 6 may not operate properly when the update of the firmware FM fails for various reasons, such as a communication error. On the other hand, in a configuration in which a script file SF is updated, when the update fails, operation data to be transmitted may be corrupted but the operation of the printer will not be affected. Therefore, for the reliability and stability of printer operation, it is preferable that the calculation rule be described in a script, as described above, and that the script be modifiable.

For the data calculation section 7, a mode in which the data calculation section 7 is realized in the printer 5, 6, and a mode in which the data calculation section 7 is realized in the computer 3, 4 that controls the corresponding printer may be considered. As illustrated in FIG. 4A, in a mode in which the printer 5 is connected to the computer (PC) 3 by a dedicated communication line, and the computer 3 is connected to the communication line 2, communication between the computer 3 and the printer 5 does not affect the traffic of the communication line 2. Therefore, all operation information may be transmitted from the printer 5 to the computer 3. Further, operation data can be generated from the operation information by the data calculation section 7, which is realized in the computer 3.

On the other hand, in the configuration illustrated in FIG. 4B, data transmitted from the printer 6 consumes bandwidth of the communication line 2 regardless of whether or not the transmission is made via the computer 4. Therefore, it is preferable that operation data in which the amount of data is reduced be transmitted from the printer 6 to the communication line 2, rather than operation information being transmitted as is. Thus, the data calculation section 7 is realized in the printer 6. Of course, operation data in which the amount of data is reduced may be transmitted from the printer 5 to the computer 3 in the configuration of FIG. 4A.

Next, operation of each section for realizing transmission of operation data will be described. In the following, a case in explained where the printer 5 becomes the object of operation to generate operation data and to transmit the operation data to the server 1. In this case, the computer 3 plays a role only in exchanging data between the server 1 and the printer 5. However, the computer 3 and the printer 5 may cooperate in realizing the operation described below. The same applies to a case where the printer 6 is directly connected to the communication line 2.

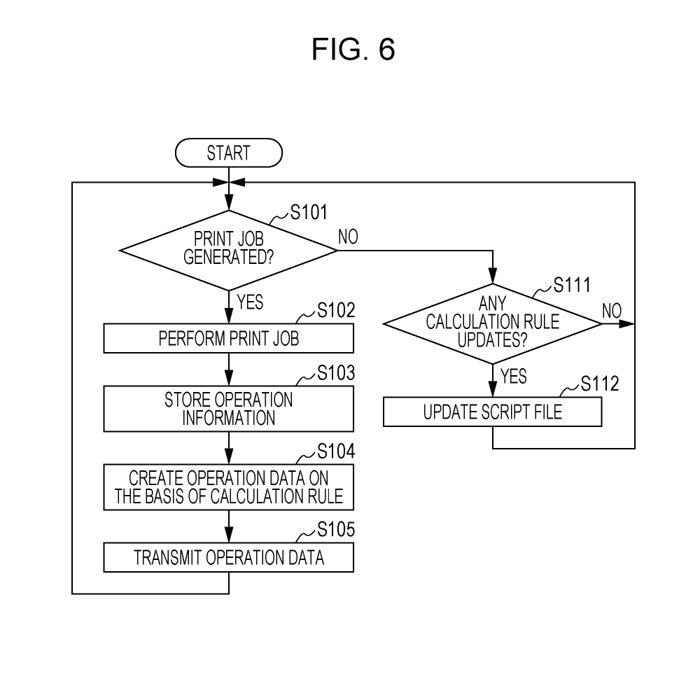

FIG. 6 is a flowchart illustrating operation on the printer side. The printer 5 is in a standby state until a print job is requested from the user or received from the computer 3. When a print job is received (step S101), the print section 54 performs the print job to form an image on a recording medium (step S102). Operation information which changes in response to the print job is updated and stored in the storage section 52 (step S103).

After the job is completed, the operation information stored in the storage section 52 is transmitted to the server 1 at predetermined timing such as a fixed interval. Specifically, on the basis of the calculation rule described in the script file SF, the data calculation section 7 generates operation data from the operation information (step S104), and the communication section 533 transmits the operation data to the communication line 2 directly or via the computer 3 (step S105). Then, the process returns to step S101, and the printer 5 waits until a new job is generated.

In a standby state, when data for updating the script file SF is transmitted from the server 1 (YES in step S111), the script file SF in the storage section 52 is updated on the basis of the data (step S112). Then, a new calculation rule is applied to the generation of operation data. After the update of the script file SF, the printer 5 returns to a standby state. This is the basic operation on the side of the printer 5.

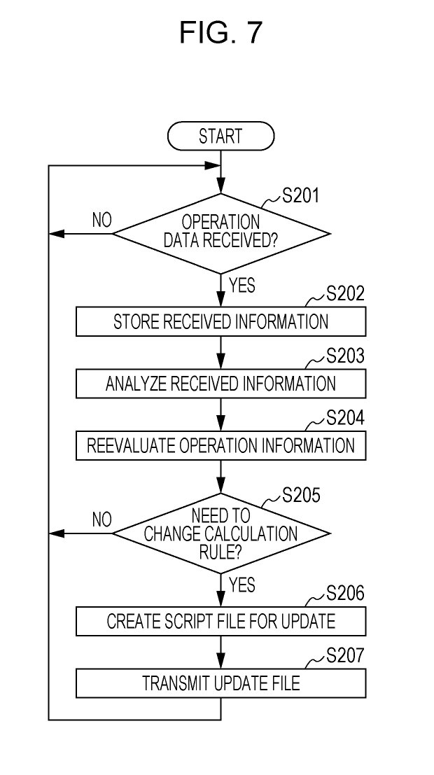

FIG. 7 is a flowchart illustrating operation on the server side. The server 1 waits for transmission of operation data from the printer 5, 6, which is connected to the communication line 2 (step S201). When receiving the operation data, the server 1 stores the operation data in the operation information accumulation section 121 (step S202).

The analysis section 112 in the server 1 analyzes the received operation data (step S203) and checks the operation condition of the printer 5, 6. In a case where it is determined to be necessary, the communication section 133 transmits (to the printer 5, 6) service information corresponding to the condition of the printer among the service information accumulated in the service information accumulation section 123.

In addition, the analysis section 112 reevaluates the validity of whether or not the operation information included in the current operation data and the calculations on the operation information are appropriate (step S204). As the evaluation method, various known analysis methods may be used. For example, correlation analysis may be applied as the evaluation method by using multiple kinds of operation information as cause factors, and failure cases occurred in the printer 5, 6 as result factors to determine the correlation between them. From the result of such an analysis, a case is included where operation information has a low correlation with a failure case, that is, low validity, and a case may be found where a plurality of failure cases having different conditions cannot be distinguished from each other by using the values of the operation information. In such a case, it is determined that the current operation rule is not appropriate, and that modification of the rule is needed (step S205).

On the basis of the analysis result, a new operation rule is created by excluding operation information having low validity from the current operation rule, adding currently excluded operation information, or changing a calculation formula. Accordingly, a script file corresponding to the new calculation rule is created (step S206). This script file for update is transmitted from the communication section 133 to the printer 5, 6 (step S207). At the same time, the script file for update is distributed to all the printers 5 and 6 of the same type, which are connected to the communication line 2. The script file SF of each printer 5, 6 is updated by the received script file for update, and therefore operation data created on the basis of the new operation rule will be transmitted from the printer 5, 6. After the update file is transmitted, or when no modification is needed, the process returns to step S201 to enter into a standby state.

When the product is released, it is not clear which operation information is usable, and therefore, a relatively large number of operation information items are included in operation data, and the amount of the operation data to be transmitted from the printer 5, 6 increases. However, as the data from the printer 5, 6 is accumulated in the server 1 and analyzed, the operation rule is improved, and thereby the amount of operation data is reduced accordingly. Note that the printer 5, 6 may be configured in such a manner that, when the first communication is established between the printer 5, 6 and the server 1 after the use of the printer 5, 6 is started, the latest operation rule at that point is transmitted to and applied to the printer 5, 6.

As described above, in the information communication system 100, the information necessary for the monitoring of the printer 5, 6 and the data analysis can be collected efficiently while suppressing loads on the storage resources in the server 1 and on the bandwidth of the communication line 2.

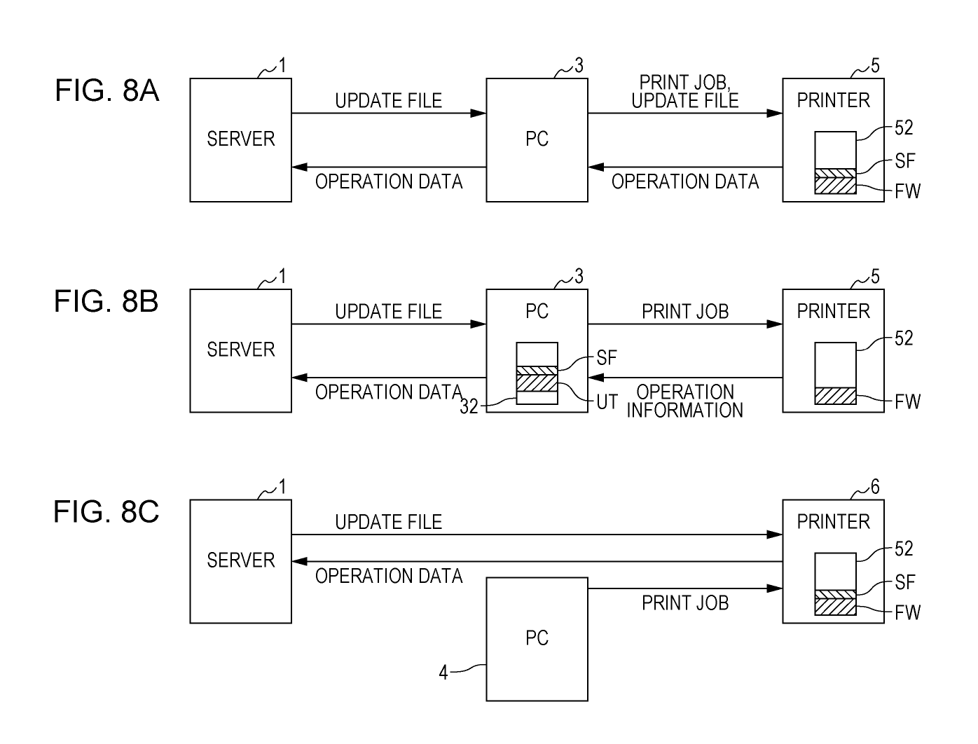

FIGS. 8A, 8B, and 8C illustrate relationships between a system configuration and a storage location of a script file. The operation example described above is of a case which has the configuration illustrated in FIG. 4A in which the computer (PC) 3 is interposed between the server 1 and the printer 5, and where the data calculation section 7 for generating operation data from operation information is mounted in the printer 5, as illustrated in FIG. 8A. In this case, the script file SF which is called by the firmware FW stored in the storage section 52 of the printer 5 is also stored in the printer 5. The computer 3 transmits a print job and a script file for update to the printer 5. From the printer 5, operation data which has been calculated is transmitted.

In the configuration illustrated in FIG. 4A, a mode, as illustrated in FIG. 8B, may also be considered in which printer 5 transmits operation information as is, and the computer 3 generates operation data from the operation information and transmits the operation data to the server 1. In this case, the data calculation section 7 needs to be mounted in the computer 3. Therefore, the data calculation section 7 is realized by means of a utility program UT which is stored in the storage section 32 of the computer 3 to manage the printer 5. In this case too, in order to prevent the control of the printer 5 from becoming unstable when the utility program UT is run, it is preferable that the calculation rule be described in a script file SF, which is called by the utility program UT.

On the other hand, in a case which has the configuration illustrated in FIG. 4B and where the operation data is transmitted from the printer 6, which is connected to the communication line 2, via the computer 4, as illustrated with a broken-line in FIG. 4B, the same applies as in the case described for FIG. 8A. If the printer 6 and the server 1 communicate directly with each other without using the computer 4, a script file SF (in which the operation rule is described) is stored in the storage section 52 of the printer 6, as illustrated in FIG. 8C. The data calculation section 7 is mounted in the printer 6, and the operation data is transmitted from the printer 6 to the server 1 directly. In this case, the computer 4 plays a role only in sending a print job to the printer 6 and monitoring the operation thereof.

As described above, the data to be communicated and the storage location for the script file SF are different depending on the connection mode. However, a common basic technical idea is implemented in these communication modes. In each mode, operation data in which the amount of data is reduced from the original operation information is transmitted, such that the server 1 can collect information necessary for the monitoring of a printer or the like without placing loads on the storage resources of the server 1 or on the bandwidth of the communication line 2. In addition, the calculation rule for generating operation data from operation information can be modified by operation by the server 1. Therefore, the contents of the operation data to be transmitted can be changed dynamically. Consequently, the operation data to be transmitted is optimized as needed, and thus, usable information can be collected efficiently. The modification of the calculation rule is performed by updating the script file, which is called by the firmware FW or the utility program UT, thereby avoiding an effect on the operation of the printer of a communication error or the like that occurred during modification.

As described above, in the embodiment, the computer 3 and the printer 5 function integrally as, or the printer 6 functions alone as, the “information processing device” of the invention. The print engine 541 provided in the printer 5, 6 functions as the “information processing section” and the “image forming section” of the invention, and the sensor 542 and the counter 543 function as the “information acquisition section” of the invention.

Furthermore, the data calculation section 7 functions as the “data generation section” of the invention, the calculation rule applied thereto corresponds to the “data generation rule” of the invention, and the operation data to be generated corresponds to the “data for transmission” of the invention. In the mode in which the data calculation section 7 is mounted in the printer 5, the function of the “data generation section” of the invention is attained by the CPU 51 running the firmware FW. Meanwhile, in the mode in which the data calculation section 7 is mounted in the computer 3, the function of the “data generation section” of the invention is attained by the CPU 31 running the utility program UT. In addition, each of the communication section 333 of the computer 3 and the communication section 533 of the printer 5 functions as the “communication section” of the invention.

Furthermore, the server 1 functions as the “information collecting device” of the invention, and the analysis section 112 functions as the “evaluation section” of the invention. In addition, the data accumulation section 12 provided in the server 1, especially the operation information accumulation section 121, functions as the “storage section” of the invention, and the CPU 11 and the communication section 133 function integrally as the “change section” of the invention.

The information communication system according to the embodiment is configured in such a manner that the data generation section runs preset firmware to operate the information processing device, the data generation rule is described in a script which can be updated and is called by the firmware, and that the change section updates the script via the communication section. According to the configuration, the data generation rule can be modified by updating only the script relating to data transmission. Therefore, the risk of reducing the stability of the operation of the information processing device is lower than in a case where firmware, for example, itself is updated.

Furthermore, the information processing device is configured to include the information processing section, the information acquisition section that acquires a plurality of kinds of operating information which change in response to the operation of the information processing section, the data generation section that generates data for transmission on the basis of the plurality of kinds of operating information and a predetermined data generation rule, and the communication section that transmits the data for transmission to the outside, and is configured in such a manner that the data generation section can modify the data generation rule according to the information received by the communication section from the outside.

According to the embodiment, the generation rule for the data for transmission, which is generated from operation information, can be modified from the outside via the communication section. Consequently, the way of transmitting the plurality of kinds of operation information can be changed dynamically. By applying the information processing device to the information communication system, necessary operation information can be transmitted in an optimized mode while suppressing the load on the communication line.

The invention is not limited to the embodiment described above, and various modifications other than those described above are conceivable unless deviating from the purpose of the invention. For example, the types of the operation information of the printer used in the explanation above are only examples, but not limited thereto.

Furthermore, the data calculation section 7 of the embodiment generates operation data on the basis of a single operation rule received from the server 1; however, several different operation rules may be used together. For example, an operation rule for generating operation data to be transmitted at each completion of a print job, and an operation rule for generating operation data to be transmitted at constant intervals can be prepared, and operation data generated on the basis of a different kind of operation information depending on the transmission timing may be transmitted.

According to the embodiment, the operation rule is modified by updating the script file SF in view of the stability of the system; however, the operation rule may also be modified by updating the entire firmware FW or the entire utility program UT, for example. In addition, printers that have already been shipped or used obviously do not have the abovementioned functions. However, by mounting script execution modules corresponding to the functions on the printers by update of the firmware, such printers can be improved ex post facto so as to be suitable for the information communication system 100.

Although the information processing device of the embodiment includes the print engine 541 of an ink jet system as the “image forming section” of the invention, the print system is optional and not limited to the ink jet system. In addition, the “information processing device” according to the invention is not limited to devices having print functions, but various electronic devices capable of connecting to the communication line 2 directly or indirectly can be embedded in the information communication system 100 as the “information processing device” of the invention. In particular, electronic devices having movable parts, parts to which a high voltage is applied, or the like, are suitable for being embedded in the information communication system of the invention.

What is claimed is:

1. An information communication system comprising:
an information processing device; and
an information collecting device that communicates with the information processing device and collects information from the information processing device,
wherein the information processing device includes an information acquisition section that acquires a plurality of kinds of operating information which change in response to the operation of the information processing device, a data generation section that generates data for transmission on the basis of the plurality of kinds of operating information and a predetermined data generation rule, and a communication section that transmits the data for transmission to the information collecting device, and
wherein the information collecting device includes a storage section that stores the data for transmission transmitted from the information processing device, and a change section that changes the data generation rule of the data generation section via the communication section of the information processing section.

2. The information communication system according to claim 1,
wherein the information collecting device is configured to be capable of communicating with a plurality of the information processing devices connected to a communication line, and
wherein the storage section stores the data for transmission transmitted from the plurality of the information processing devices.

3. The information communication system according to claim 2,
wherein the information collecting device includes an evaluation section that evaluates the validity of the plurality of kinds of operating information on the basis of the data for transmission transmitted from the plurality of information processing devices, and that creates a new data generation rule on the basis of an evaluation result.

4. The information communication system according to claim 1,
wherein the data generation section runs preset firmware to operate the information processing device,
wherein the data generation rule is described in a script which can be updated and is called by the firmware, and
wherein the change section updates the script via the communication section.

5. An information processing device comprising:
an information processing section;
an information acquisition section that acquires a plurality of kinds of operating information which change in response to the operation of the information processing section;
a data generation section that generates data for transmission on the basis of the plurality of kinds of operating information and a predetermined data generation rule; and
a communication section that transmits the data for transmission to outside,
wherein the data generation section can change the data generation rule according to information received by the communication section from outside.

6. The information processing device according to claim 5,
wherein the data generation section runs preset firmware to operate the information processing device, and
wherein the data generation rule is described in a script which can be updated and is called by the firmware.

7. The information processing device according to claim 5,
wherein the information acquisition section has a sensor that detects a physical parameter which changes in response to the operation of the information processing section, and
wherein an output signal of the sensor is used as the operation information.

8. The information processing device according to claim 5,
wherein the information acquisition section has a counter that counts a numerical value which changes in response to the operation of the information processing section, and
wherein an output signal of the counter is used as the operating information.

9. The information processing device according to claim 5,
wherein the information processing section has an image forming section that forms an image based on image data on a recording medium.

10. An information collecting method for collecting information from an information processing device connected to a communication line, comprising:
receiving, from the information processing device, data for transmission that is generated on the basis of a plurality of kinds of operation information which change in response to the operation of the information processing device and a data generation rule given in advance to the information processing device;
storing the received data for transmission; and
updating the data generation rule on the basis of the data for transmission.

11. The information collecting method according to claim 10, further comprising:
evaluating the validity of the plurality of kinds of operating information on the basis of the data for transmission transmitted from a plurality of information processing devices to create a new data generation rule on the basis of an evaluation result.

12. The information collecting method according to claim 10, further comprising:
receiving the data for transmission from the plurality of information processing devices which are connected to a communication line to store the data for transmission.
